(19) United States
(12) Patent Application Publication
(10) Pub. No.: US 2026/0285378 A1
(43) Pub. Date: Sep. 24, 2026

(54) RAIL VEHICLE AND METHOD FOR CAPTURING A TRACK GAUGE COURSE

(71) Applicant: PLASSER & THEURER EXPORT VON BAHNBAUMASCHINEN GESELLSCHAFT M.B.H., Wien (AT)

(72) Inventors: David BUCHBAUER, Steinakirchen am Forst (AT); Christian OBEXER, Velletri (IT)

(21) Appl. No.: 18/868,878

(22) PCT Filed: May 17, 2023
(86) PCT No.: PCT/EP2023/063225

§ 371 Date: Nov. 25, 2024

(30) Foreign Application Priority Data
May 24, 2022 (AT) A50364/2022

(51) Int. Cl. B61K 9/08; B61L 23/04; B61L 25/02

(52) U.S. Cl. CPC B61K 9/08; B61L 23/047; B61L 25/026

(57) ABSTRACT

A rail vehicle includes a vehicle frame movable on a track and supported on bogies. A first track gauge measurement system for capturing a first track gauge course is disposed on the rail vehicle. A second track gauge measurement system for capturing a second track gauge course is disposed at a distance therefrom in the vehicle longitudinal direction. Both track gauge measurement systems are coupled to a higher-level analysis device in which an algorithm is configured to determine an offset of the two track gauge courses, in order to determine the forward movement of the rail vehicle using the offset of the two track gauge courses. A method for operating a rail vehicle is also provided.

### FIELD OF TECHNOLOGY

The invention relates to a rail vehicle with a vehicle frame which is supported on rail running gears and can be moved on a track, with a first track gauge measurement system for recording a first course of a track gauge being arranged on the rail vehicle. The invention additionally relates to a method for operating such a rail vehicle.

### PRIOR ART

A rail vehicle with a track gauge measurement system and a method for operating the rail vehicle are known, for example, from publication AT 514667 A1. First, position data of a track are recorded by the track inspection vehicle and target position data is created therefrom. At the same time, the course of the track gauge is recorded continuously. Subsequent track maintenance using the tamping machine is based on the target position data, with a track gauge measurement being carried out again for location synchronization. This utilizes a characteristic property of the track gauge, namely a continuous slight change along a track. These irregular change patterns in the track gauge can be used to identify each point of the track.

### PRESENTATION OF THE INVENTION

The object of the invention is to improve a rail vehicle of the type mentioned above in such a way that the characteristic property of the track gauge known from prior art can be utilized for other purposes. In addition, a corresponding method is to be indicated.

According to the invention, these objects are achieved by the features of independent claims 1 and 7. Dependent claims indicate advantageous embodiments of the invention.

A second track gauge measurement system for recording a course of a second track gauge is arranged on the rail vehicle at a spacing in the longitudinal direction of the vehicle, with both track gauge measurement systems being coupled to a higher-level analysis device in which an algorithm is set up to determine an offset of the two courses of the track gauge. Due to the characteristic course of the track gauge, both track gauge measurement systems record the same result data. However, the first track gauge measurement system records the track gauge data earlier than the second track gauge measurement system, which results in the time offset or the offset in the longitudinal direction of the track. In this way, the forward movement of the rail vehicle can be determined using the offset of the two courses of the track gauge.

In an advantageous further development, an algorithm is set up in the analysis device to calculate a travelling speed and/or a covered travel distance from the time offset of the two courses of the track gauge and the known spacing between the two track gauge measurement systems. The track gauge measurement systems thus serve as speedometers or distance meters for the travel distance covered by the rail vehicle on the track. Synergy effects can be achieved if the track gauge measurement systems also serve other purposes, for example to determine the track position or to measure voids.

In a further advantageous embodiment of the invention, a distance measurement sensor (odometer) is arranged on a wheel axle, with the distance measurement sensor being coupled to the analysis device for checking a measured travel distance. This solution is particularly useful for existing vehicles that are already equipped with a distance measurement sensor and utilize the data from this sensor. Through the check performed by the track gauge measurement systems and the analysis device, sliding phases of the rail vehicle's wheels can be detected. For example, the recorded track gauge data are logged over the travel distance measured by the distance measurement sensor. In such an analysis, the offset of the two courses of the track gauge only corresponds to the spacing between the two track gauge measurement systems if there is no slip between the wheels and the track. As soon as deviations are detected, the travel distance recorded by the distance measurement sensor is corrected accordingly.

Advantageously, each track gauge measurement system comprises two gauge recording units, particularly light-section sensors, each of which is set up for non-contact recording of a rail of the track. With such a non-contact system, track gauge measurement can also be carried out at high speeds. Mechanical systems with spreading axles or measuring transducers are generally only designed for low measuring speeds.

In a preferred variant, a work unit for maintaining the track is arranged on the vehicle frame, with a spacing between the work unit and at least one of the track gauge measurement systems being stored in the analysis device. In this way, the position of the work unit in relation to the track can be precisely determined. For example, a tamping unit is positioned exactly above a sleeper to be tamped.

It is useful for one track gauge measurement system to be arranged on a front rail running gear and the other track gauge measurement system on a rear rail running gear. The fasteners of the two track gauge measurement systems to the two rail running gears can be designed identically, with the spacing in the longitudinal direction of the vehicle being favourable for determining the offset of the two courses of the track gauge.

In the method according to the invention for operating the rail vehicle, a course of the track gauge is recorded by means of the respective track gauge measurement system, with the courses of the track gauge being fed to the common analysis device and with an offset of the two courses of the track gauge being determined by means of an algorithm set up in the analysis device. Minor deviations between the two courses of the track gauge due to measurement errors are not taken into account. For example, the two courses of the track gauge are matched and the offset is determined on the basis of relative maximum values.

In an advantageous further development, a travelling speed and/or a covered travel distance is determined from the time offset of the two courses of the track gauge and the spacing between the two track gauge measurement systems by means of an algorithm set up in the analysis device. This method extension can be used as a replacement for or for checking an electromechanical distance meter.

A further improvement of the method utilizes the track gauge measurement systems for integrity checks by measuring a travel distance by means of a distance measurement sensor arranged on a wheel axle and checking the measured travel distance in the analysis device by comparing it with the offset of the two courses of the track gauge.

In an advantageous extension, a work unit arranged on the vehicle frame is positioned above the track based on the offset of the two courses of the track gauge. In this way, the recording of the travel distance by means of the track gauge measurement systems is used to improve the quality of the automated or partially automated positioning of work units on the track.

### BRIEF DESCRIPTION OF THE DRAWINGS

In the following, the invention is explained by way of example with reference to the accompanying figures. The following figures show in schematic illustrations:

FIG. 1 Rail vehicle with a plurality of track gauge measurement systems

FIG. 2 Cross section of the rail vehicle on a track

FIG. 3 Travelling speed measurement with two track gauge measurement systems

FIG. 4 Measurement result of a distance measurement sensor with integrity check

FIG. 5 Measurement result according to FIG. 4 with incorrect measurement of the distance measurement sensor

### DESCRIPTION OF THE EMBODIMENTS

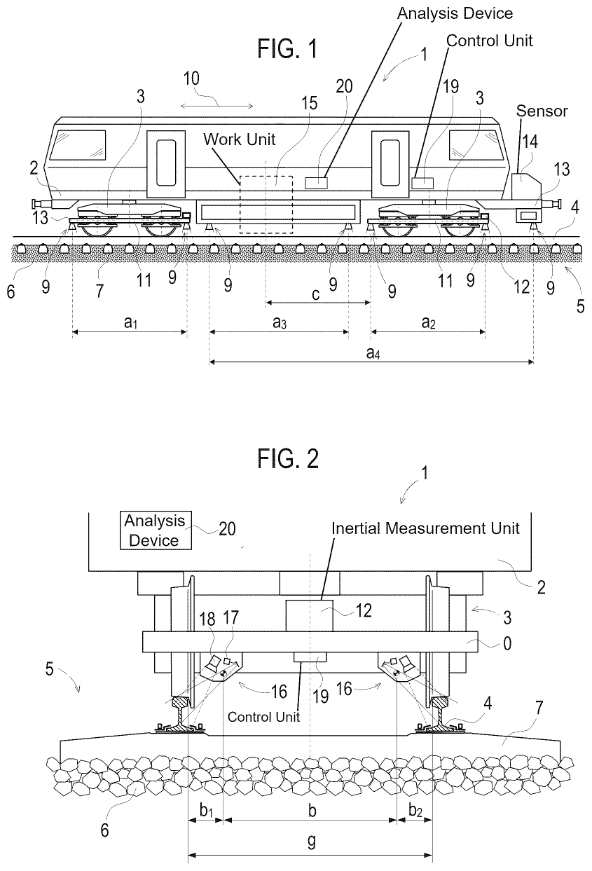

FIG. 1 shows a rail vehicle 1 with a vehicle frame 2, which can be moved on rail running gears 3 on rails 4 of a track 5. The rails 4 with a predefined track gauge g are fastened to sleepers 7 supported in a ballast bed 6. The invention also relates to a ballastless track not shown, in which the rails 4 are fastened to a fixed superstructure of concrete. For example, the standard track gauge in large parts of Europe is 1435 mm. This specifies the spacing between the inner edges of the rail heads of a track 5. The present invention utilizes the fact that the track gauge g varies within a tolerance range and that, in this way, each section of the track 5 has a characteristic course of the track gauge g.

In the examples with reference to FIGS. 1-3, the track gauge g is measured by means of non-contact track gauge measurement systems 9. Measurement systems that include spreading axles pressed against the inner edges of the rails 4 or that comprise measuring transducers resting against the inner edges can also be used. According to the invention, at least two track gauge measurement systems 9 are arranged one behind the other in the longitudinal direction of the vehicle 10. A total of seven track gauge measurement systems 9 are arranged on the rail vehicle 1 in FIG. 1.

Each of the two rail running gears 3 comprises two track gauge measurement systems 9 on a common measurement frame 11. The respective measurement frame 11 is connected to the wheel axles of the assigned rail running gear 3. In this way, no suspension travels of the rail running gear 3 are transferred to the measurement frame 11, so that only lateral pendulum movements of the wheel axles have to be compensated for during the gauge measurement. By means of these track gauge measurement systems 9, for example, the exact position of an inertial measurement unit 12 (IMU) fastened to the measurement frame 11 can be recorded in relation to the respective rail 4.

Another track gauge measurement system 9 is arranged on a measurement platform 13 in the front area of the rail vehicle 1. This makes it possible to record the movement of the measurement platform 13 and the sensors 14 fastened thereto in relation to the rails 4. Two further track gauge measurement systems 9 are fastened to the vehicle frame between the two rail running gears 3 and enable the recording of movements of the vehicle frame 2 in relation to the rails 4. This also makes it possible to record the position of a work unit 15 (e.g. tamping unit) arranged on the vehicle frame 2 in relation to the track 5.

Each of the track gauge measurement systems 9 comprises a gauge recording unit 16 for each of the two rails 4 of the track 5, as shown in FIG. 2. The respective gauge recording unit 16 is, for example, a light-section sensor with a laser source 17 and an optical detector 18. Advantageously, both gauge recording units 16 are coupled to a common control unit 19. The fixed spacing b between the two gauge recording units 16 is stored in the control unit 19. With the measured spacings b₁, b₂ to the respective inner edge of the rail, this results in the currently measured track gauge g.

At least two track gauge measurement systems 9 fastened to the rail vehicle 1 have a fixed spacing a, a₁, a₂, a₃, a₄ in relation to each other in the longitudinal direction of the vehicle 10. In FIG. 1, these are the spacings a₁, a₂ of the track gauge measurement systems 9 fastened to the rail running gears 3 as well as the spacings a₃, a₄ of the track gauge measurement systems 9 arranged on the vehicle frame 2 and on the front measurement platform 13. The respective spacings a, a₁, a₂, a₃, a₄ are stored in a common analysis device 20.

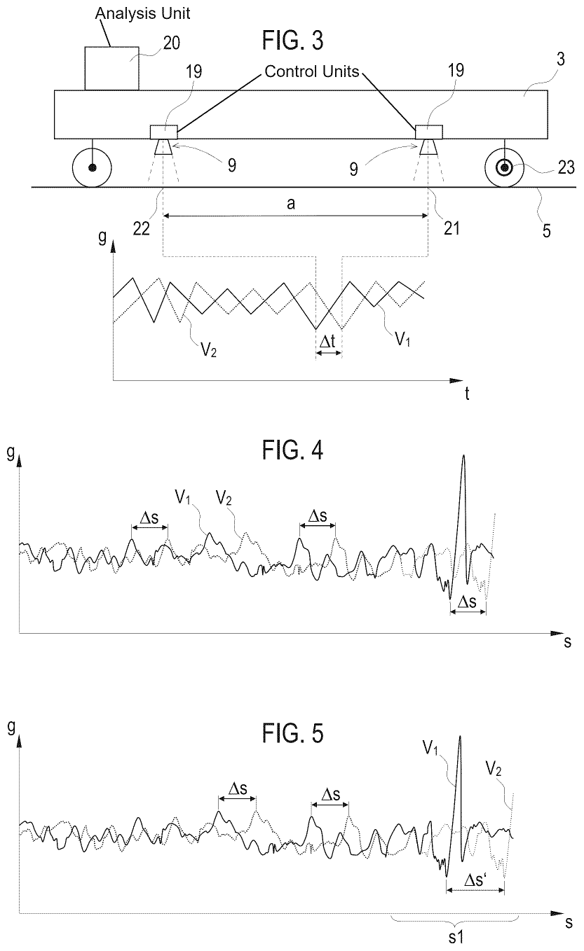

With reference to FIG. 3, one of the rail running gears 3 with two track gauge measurement systems 9 arranged one behind the other is examined in more detail. The fixed spacing a between the two track gauge measurement systems 9 is stored in a common analysis device 20. The front track gauge measurement system 9 measures the track gauge g at a first measurement point 21 of the track 5 and the rear track gauge measurement system 9 measures the track gauge g at a second measurement point 22 of the track 5. Due to the tolerance range of the track gauge g, these two measurement results deviate slightly from each other.

During forward travel of the rail vehicle 1, each track gauge measurement system 9 records a course of a track gauge V₁, V₂ over a travelling time t or over a travel distance s. The diagram in FIG. 3 shows the respective course of the track gauge V₁, V₂ over the travelling time t. Because both track gauge measurement systems 9 measure the same track 4 directly one after the other, this results in two approximately identical courses of a track gauge V₁, V₂ with a time offset Δt. The course of the track gauge V₁ recorded by the front track gauge measurement system 9 is shown with a solid line. Shifted by the time offset Δt in the direction of the time axis t, the course of the track gauge V₂ recorded by the rear track gauge measurement system 9 is shown with a dotted line.

The current time offset Δt is calculated by means of an analysis algorithm in the analysis device 20. For example, a local maximum or minimum of the first course of a track gauge V₁ is registered and the time period until the occurrence of the same local maximum or minimum of the second course of the track gauge V₂ is recorded as an offset Δt. The spacing a between the track gauge measurement systems 9 is then used to calculate the current speed of the rail vehicle 1 using the analysis device 20: v=a/Δt. The covered distance s is calculated by integrating the speed.

In an extension of the invention, the rail vehicle 1 comprises an odometer 23 arranged on a wheel axle of one of the rail running gears 3. An encoder is usually attached to one end of the wheel axle. The odometer 23 serves as a distance meter for various functions of the rail vehicle 1. For example, the rail vehicle 1 is designed as a track inspection vehicle or as a tamping machine with a tamping unit 15. In both cases, the odometer 23 is used to determine the distance travelled by the machine. Other measuring devices arranged on the rail vehicle 1 are compared with the data from the odometer 23. The result data are therefore the result of a sensor fusion.

This also applies to the track gauge measurement systems 9. In this way, the continuously recorded track gauge data are logged over the distance s measured by the odometer 23. Corresponding diagrams are shown in FIGS. 4 and 5. The course of the track gauge V₁ recorded by the front track gauge measurement system 9 is again shown as a solid line. The course of the track gauge V₂ recorded by the rear track gauge measurement system 9 is shown with a dotted line.

Due to the track gauge recording over the distance s, the two courses of the track gauge V₁, V₂ exhibit a constant offset regardless of the vehicle speed if the distance recording functions correctly. This is the case in FIG. 4. Specifically, the offset Δs of the two courses of the track gauge V₁, V₂ corresponds to the spacing a between the two track gauge measurement systems 9.

Advantageously, the recording of the courses of the track gauge V₁, V₂ over the distance s is used to continuously check the distance measurement. In this way, any slip of the wheel axle on which the odometer 23 is arranged is detected and subsequently compensated for. FIG. 5 shows a diagram by means of which spinning of the wheel axle used for distance measurement is detected. In a distance section s1, the two courses of the track gauge V₁, V₂ have an offset Δs′ that is significantly greater than the spacing a between the two track gauge measurement systems 9.

The current offset Δs, Δs′ is determined as before in the analysis device 20 using an analysis algorithm based on local minima or maxima of both courses V₁, V₂. As soon as there is a current offset As outside a tolerance range around the spacing a, the distance measurement data specified by the odometer 23 are compensated for accordingly. In this example, the measurement result recorded by the odometer 23 in the range s1 is shortened by the difference between the spacing a and the incorrect offset Δs′.

In another method, the two courses of the track gauge V₁, V₂ are superimposed and compared over the covered distance s. If the measured courses of the track gauge V₁, V₂ are congruent with the expected location —which is known—the odometer 23 has functioned correctly over this distance.

In this way, constant checking of the odometer 23 or of a recorded encoder signal is possible so that any slip is detected and process reliability is increased. Furthermore, by analysing the measured courses of the track gauge V₁, V₂, a wheel wear of the rail running gear 3 equipped with the odometer 23 can be detected. The analysis device 20 recursively determines the reduction in wheel diameter associated with wheel wear and automatically readjusts the odometer 23.

The arrangement of a plurality of track gauge measurement systems 9 facilitates calibration in an improved embodiment. In a first step, one of the track gauge measurement systems 9 is precisely calibrated at a track point, for example using a calibration bar. The rail vehicle 1 is then set in motion and the other track gauge measurement systems 9 are calibrated automatically. As soon as the respective track gauge measurement system 9 is at the same track point, the measured values are compared with the measurement results of the previously precisely calibrated track gauge measurement system 9.

1-10. (canceled)

11. A rail vehicle, comprising:
a vehicle frame having a longitudinal direction and being movable on a track having a track gauge;
rail running gears supporting said vehicle frame;
a first track gauge measurement system disposed on the rail vehicle for recording a first course of the track gauge;
a second track gauge measurement system disposed at a spacing in the longitudinal direction of the vehicle from said first track gauge measurement system, for recording a second course of the track gauge; and
a higher-level analysis device coupled to said first and second track gauge measurement systems, said analysis device having an algorithm for determining an offset of the first and second courses of the track gauge.

12. The rail vehicle according to claim 11, wherein said analysis device has an algorithm calculating at least one of a travelling speed or a covered travel distance from said time offset of the first and second courses of the track gauge and a known spacing between said first and second track gauge measurement systems.

13. The rail vehicle according to claim 11, which further comprises a distance measurement sensor disposed on a wheel axle, said distance measurement sensor being coupled to said analysis device for checking a measured travel distance.

14. The rail vehicle according to claim 11, wherein each of said track gauge measurement systems includes two respective gauge recording units each configured for non-contact recording of a rail of the track.

15. The rail vehicle according to claim 14, wherein said gauge recording units are light-section sensors.

16. The rail vehicle according to claim 11, which further comprises a work unit disposed on said vehicle frame for maintaining the track, said analysis device storing a spacing between said work unit and at least one of said first and second track gauge measurement systems.

17. The rail vehicle according to claim 11, wherein said rail running gears include front and rear rail running gears,, one of said track gauge measurement systems is disposed on said front rail running gear and another of said track gauge measurement systems is disposed on said rear rail running gear.

18. A method for operating a rail vehicle, the method comprising:
providing the rail vehicle according to claim 11;
using said first and second track gauge measurement systems to record the respective first and second courses of the track gauge;
feeding the courses of the track gauge to said analysis device; and
using the algorithm in said analysis device to determine the offset of the first and second courses of the track gauge.

19. The method according to claim 18, which further comprises using an algorithm in said analysis device to determine at least one of a travelling speed or a covered travel distance from a time offset of the first and second courses of the track gauge and a spacing between said first and second track gauge measurement systems.

20. The method according to claim 18, which further comprises using a distance measurement sensor disposed on a wheel axle to measure a travel distance, and checking the measured travel distance in said analysis device by comparing the measured travel distance with the offset of the first and second courses of the track gauge.

21. The method according to claim 18, which further comprises positioning a work unit on said vehicle frame above the track based on the offset of the first and second courses of the track gauge.
